(19) United States
(12) Patent Application Publication
(10) Pub. No.: US 2006/0288532 A1
(43) Pub. Date: Dec. 28, 2006

(54) Door hinge device and electronic appliances having the same

(75) Inventor: Il Kwun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/294,557

(22) Filed: Dec. 6, 2005

(30) Foreign Application Priority Data
Jun. 28, 2005 (KR) 2005-56211

(51) Int. Cl. E05D 7/10

(52) U.S. Cl. 16/267

(57) ABSTRACT

A door hinge device includes a hinge shaft fixed to a body of an appliance and having a damping protrusion on one side of an outer surface, and a coupling member having a shaft engaging hole coupled to an outer surface of the hinge shaft. The shaft engaging hole includes a holding portion having an inner diameter corresponding to an outer diameter of the hinge shaft and a damping portion having a larger inner diameter than the outer diameter of the hinge shaft and surrounding the damping protrusion. The damping portion includes a separation section separated from the damping protrusion when the door is closed, and a contact section contacting the damping protrusion when the door is opened. The door hinge device can prevent slamming or trembling when the door is opened or closed, and has a simple configuration.

### CROSS-REFERENCE TO RELATED APPLICATION

This application claims the benefit of Korean Patent Application No. 2005-56211, filed on Jun. 28, 2005 in the Korean Intellectual Property Office, the disclosure of which is incorporated herein its entirety by reference.

### BACKGROUND OF THE INVENTION

1. Field of the Invention

An aspect of the present invention relates to a door hinge device, and, more particularly, to a door hinge device, which has a simple configuration, allows easy manufacturing, and prevents slamming or trembling of a door when the door is opened or closed, and an electronic appliance including the same.

2. Description of the Related Art

Generally, electronic appliances such as television sets and video cassette recorders include an operating unit having a plurality of operating buttons, and a door for opening/closing the operating unit. The door is typically coupled to a body of the electronic appliance to open or close the operating unit. A door damper prevents the door from slamming or trembling when the door is opened or closed.

Korean Utility Model Registration No. 20-0152876 (Publication Date: Aug. 2, 1999) discloses one example of the door damper which is designed to prevent a door from slamming or trembling when the door is opened or closed. The door damper includes an oil damper having a damping gear, and a door gear provided to the door. The damping gear is engaged with the door gear, so that the door can be slowly opened or closed.

However, in the electronic appliance of the disclosure, the gear type door damper having such a complicated configuration must be coupled to a hinge device of the door in order to prevent the slamming or trembling of the door when the door is opened or closed. Furthermore, this type of arrangement, increases manufacturing costs.

### SUMMARY OF THE INVENTION

Aspects of the present invention have been made in view of the above and/or other problems, and an aspect of the present invention is to provide a door hinge device, which can prevent a door from slamming or trembling when the door is opened or closed, and has a simple configuration, thereby lowering manufacturing costs, and an electronic appliance including the same.

In accordance with an aspect of the present invention, there is provided a door hinge device coupling a door to a body of an electronic appliance, including: a hinge shaft fixed to the body of the appliance and having a damping protrusion on one side of an outer surface of the hinge shaft; and a coupling member provided to the door and having a shaft engaging hole engaging with an outer surface of the hinge shaft, wherein the shaft engaging hole includes a holding portion having an inner diameter corresponding to an outer diameter of the hinge shaft, and a damping portion having a larger inner diameter than the outer diameter of the hinge shaft and surrounding the damping protrusion, the damping portion including a separation section separated from the damping protrusion when the door is closed, and a contact section contacting the damping protrusion when the door is opened.

According to another aspect of the present invention, the coupling member includes an opening/closing protrusion formed on the outer surface thereof, and a resilient member provided to the body such that, when the door is opened or closed, the resilient member compresses the opening/closing protrusion to allow the door to be smoothly opened or closed.

According to another aspect of the present invention, the coupling member includes an open portion opened in a radial direction of the shaft engaging hole and having a narrower width than the outer diameter of the hinge shaft such that the hinge shaft enters the open portion and engages with the coupling member.

According to another aspect of the present invention, the opening/closing protrusion extends from one end at the open portion of the coupling member to the resilient member.

According to another aspect of the present invention the resilient member includes a flexible arm or member provided to compress the opening/closing protrusion, and the flexible arm or member includes an opening guide surface slanted to compress the opening/closing protrusion in an opening direction of the door when the door is opened, and a closing guide surface slanted to compress the opening/closing protrusion in a direction of closing the door when the door is closed.

In accordance with another aspect of the present invention, there is provided an electronic appliance having a body, a door coupled to the body, and a door hinge device to hingably couple the door to the body, wherein the door hinge device includes a hinge shaft fixed to the body of the appliance and having a damping protrusion on one side of an outer surface of the hinge shaft; and a coupling member provided to the door and having a shaft engaging hole engaging with an outer surface of the hinge shaft, the shaft engaging hole including a holding portion having an inner diameter corresponding to an outer diameter of the hinge shaft, and a damping portion having a larger inner diameter than the outer diameter of the hinge shaft and surrounding the damping protrusion, the damping portion including a separation section separated from the damping protrusion when the door is closed, and a contact section contacting the damping protrusion when the door is opened.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is an exploded perspective view illustrating an electronic appliance having a door hinge device in accordance with an aspect of the present invention;

FIG. 2 is a perspective view illustrating a hinge shaft and a resilient member of the door hinge device in accordance with an aspect of the present invention;

FIG. 3 is a perspective view illustrating a coupling member of the door hinge device in accordance with an aspect of the present invention; and

FIGS. 4 to 7 are cross-sectional views illustrating the states of the door hinge device in accordance with an aspect of the present invention, as the door is opened or closed.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Although a door hinge device according to an aspect of the present invention can be applied to a door of an electronic appliance (such as typical video cassette recorders, DVD players, Blu ray and/or HD-DVD players, televisions, audio appliances, set top boxes, and the like), the following description refers to the door hinge device of the invention as applied to video cassette recorders.

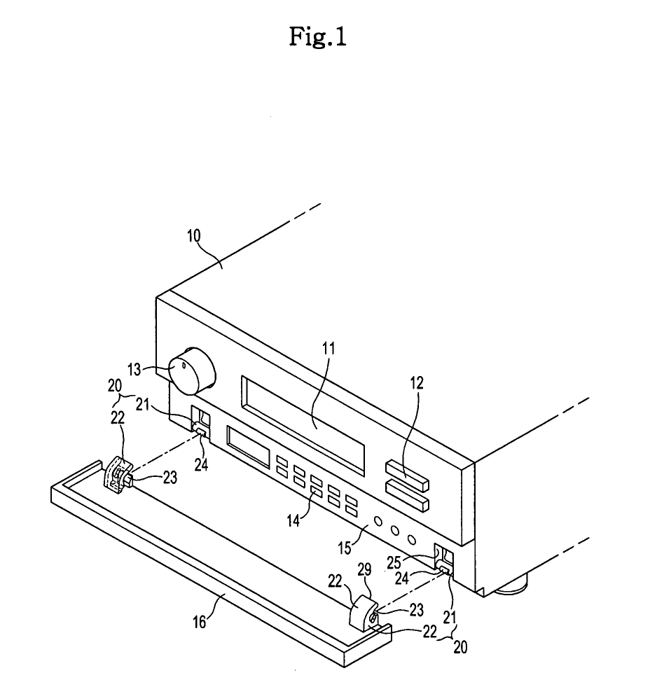

In FIG. 1, the video cassette recorder having the door hinge device according to an aspect of the present invention includes a body 10, a video cassette input port 11 formed at a front side of the body 10, a power button 12, and an operation control knob 13. Additionally, the video cassette recorder is provided at a lower portion of the front side of the body 10 with an operating unit 15 having a plurality of operating buttons 14 to control various functions, such as reservation of recording, control of picture quality, setting of language, and the like. The operating unit 15 is opened or closed by the door 16 hinging up and down.

The door 16 for opening and closing the operating unit 15 is hingably coupled at both lower sides of the body 10. For this purpose, door hinge devices 20 are provided at both sides of the door 16 and at the body 10 to couple the door 16 to the body 10. However, it is understood that other locations are possible, and that fewer or more hinges can be used.

Each of the door hinge devices 20 includes a hinge shaft 21 provided at end sides of the operating unit 15 of the body 10, and a coupling member 22 provided at a lower portion of one side of the door 16 so as to be coupled to the hinge shaft 21 and having a shaft engaging hole 23 fitted to an outer surface of the hinge shaft 21.

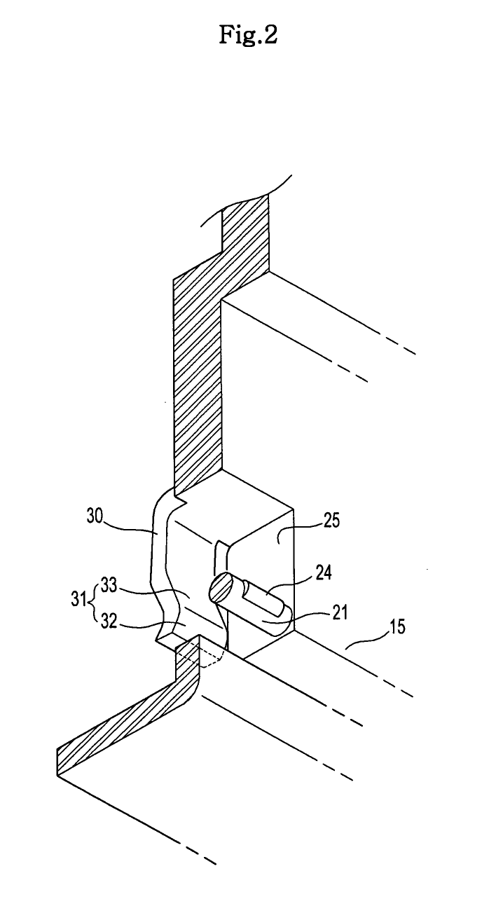

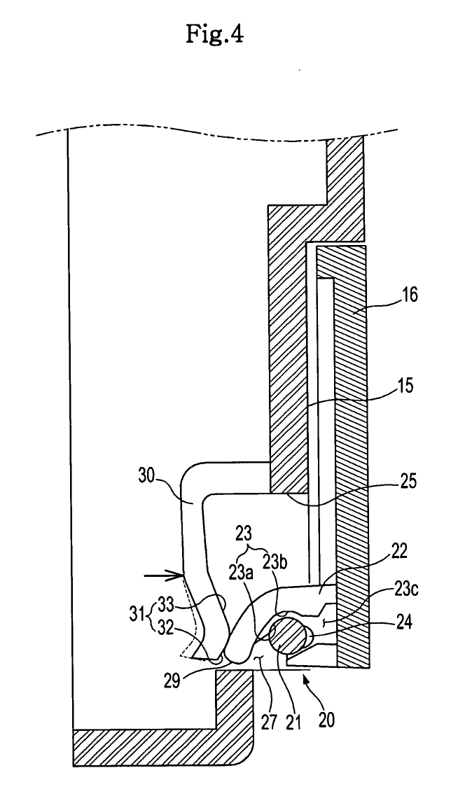

As shown in FIGS. 2 and 4, the hinge shaft 21 is integrally formed to the operating unit 15, and includes a damping protrusion 24 protruding from one side of the outer surface of the body to engage with the coupling member 22 and prevent the door 16 from slamming or trembling when the door 16 is opened. The damping protrusion 24 has a rounded outer surface. An open portion 25 is defined around the hinge shaft 21 on the operating unit 15 so as to allow the coupling member 22 to be hingably coupled to the hinge shaft 21.

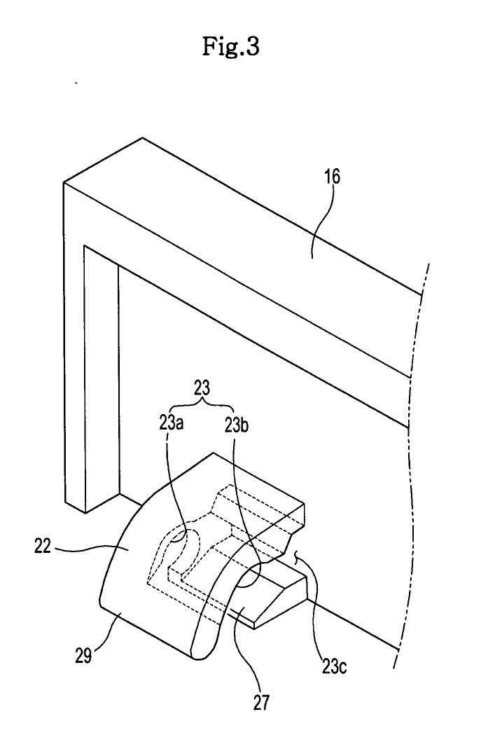

As shown in FIGS. 3 and 4, the coupling member 22 protrudes from an inner surface of the door 16 towards the hinge shaft 21, and is provided with an open portion 27 cut to have a slightly smaller width than an outer diameter of the hinge shaft 21 so as to allow the hinge shaft 21 to enter the shaft engaging hole 23. As such, the width of the open portion 27 is slightly smaller than the outer diameter of the hinge shaft 21, so that, when the hinge shaft 21 is inserted into the shaft engaging hole 23 through the open portion 27, the hinge shaft 21 can be inserted in the shaft engaging hole 23 via elastic deformation of the coupling member 22, and after being inserted in the hinge shaft 21, the hinge shaft 21 can be prevented from being separated from the coupling member 22.

The shaft engaging hole 23 of the coupling member 22 includes a holding portion 23a having an inner diameter corresponding to the outer diameter of the hinge shaft 21, and a damping portion 23b having a larger inner diameter than the outer diameter of the hinge shaft 21 and surrounding the damping protrusion 24 of the hinge shaft 21. With this structure, when the coupling member 22 is coupled to the hinge shaft 21, the holding portion 23a of the shaft engaging hole 23 engages with a portion of the hinge shaft 21 where the damping protrusion 24 is not formed on the hinge shaft 21, and the damping protrusion 24 engages with the hinge shaft 21 in such a way that the damping protrusion 24 of the hinge shaft 21 surrounds an outer side of the hinge shaft 21 where the damping protrusion 24 is formed on the hinge shaft 21. As a result, when opening or closing the door 16, the door 16 is hinged to the holding portion 23a and brought into contact with the outer surface of the hinge shaft 21, allowing the door to be opened or closed without trembling. At the same time, the damping protrusion 24 of the hinge shaft 21 contacts the inner surface of the damping portion 23b, preventing the door 16 from suffering slamming or trembling.

Additionally, the damping portion 23b of the shaft engaging hole 23 is provided with a separation section spaced from the damping protrusion 24 while the door 16 is closed, and a contact section is brought into contact with the damping protrusion 24 when the door 16 is opened. The separation section is a separation groove 23c depressed radially from the damping portion 23b. The contact section is defined in the inner surface of the damping portion 23b excluding the separation groove 23c.

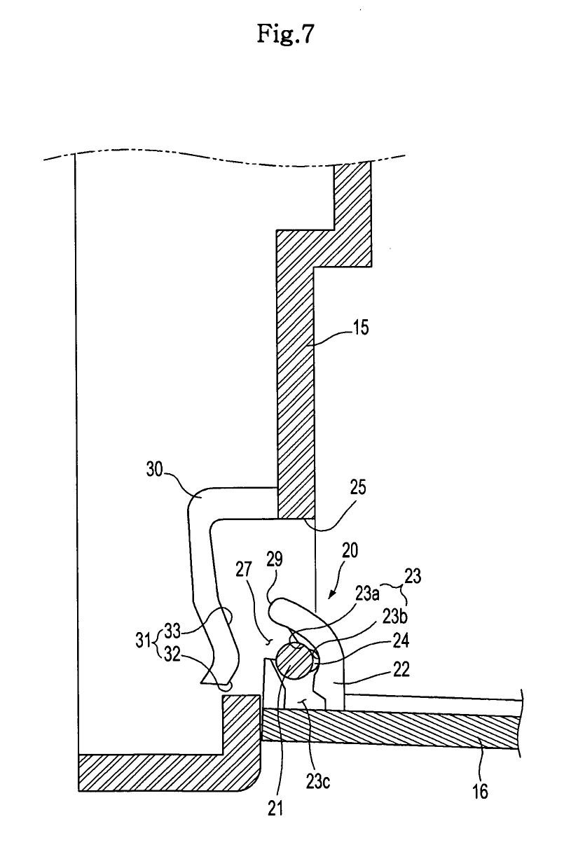

With this structure, as shown in FIG. 4, when the door 16 is closed, the damping protrusion 24 of the hinge shaft 21 can be located in the separation groove 23c, and, as shown in FIG. 7, when the door 16 is opened, the damping protrusion 24 of the hinge shaft 21 can be brought into contact with the inner surface of the damping portion 23b. As a result, at an initial stage of opening the door 16, the damping protrusion 24 is located in the separation groove 23c to allow the door 16 to be easily opened, and at a final stage of opening the door 16, the damping protrusion 24 is brought into contact with the inner surface of the damping portion 23b to allow the door 16 to be slowly opened, preventing the door 16 from slamming and/or trembling. In order to allow operation of the door hinge device, it is desirable that the coupling member 22 have a predetermined resilience such that the inner surface of the damping portion 23b slightly compresses the damping protrusion 24.

Additionally, as shown in FIG. 4, the door hinge device 20 of the invention includes an opening/closing protrusion 29 outwardly extending from one end at the open portion 27 of the coupling member 22, and a resilient member 30 provided at a rear side of the hinge shaft 21 of the body 10 such that the resilient member 30 compresses the opening/closing protrusion 29 allowing the door to be smoothly opened or closed.

The resilient member 30 extends a predetermined length downward from an inner surface of the operating unit 15 above the hinge shaft 21 so as to contact the opening/closing protrusion 29 of the coupling member 22, and has a flexible arm 31 formed at a free end of the resilient member 30 so as to compress the opening/closing protrusion 29. The flexible arm 31 includes an opening guide surface 33 slanted to compress the opening/closing protrusion 29 of the coupling member 22 in an opening direction of the door 16 when the door 16 is opened, and a closing guide surface 32 slanted to compress the opening/closing protrusion 29 of the coupling member 22 in a direction of closing the door 16 when the door 16 is closed. With this structure, when the opening/closing protrusion 29 is brought into contact with the opening guide surface 33 during opening or closing of the door 16, the door 16 can be hinged in an opening direction via resilient force of the resilient member 30 and the opening guide of the opening guide surface 33, and when the opening/closing protrusion 29 is brought into contact with the closing guide surface 32, the door 16 can be hinged in a closing direction via the resilient force of the resilient member 30 and the closing guide of the closing guide surface 32. As shown, the flexible arm 31 has a V shape. However, it is understood that other shapes and/or devices can be used to provide a biasing functionality instead of or in addition to the shown arm 31.

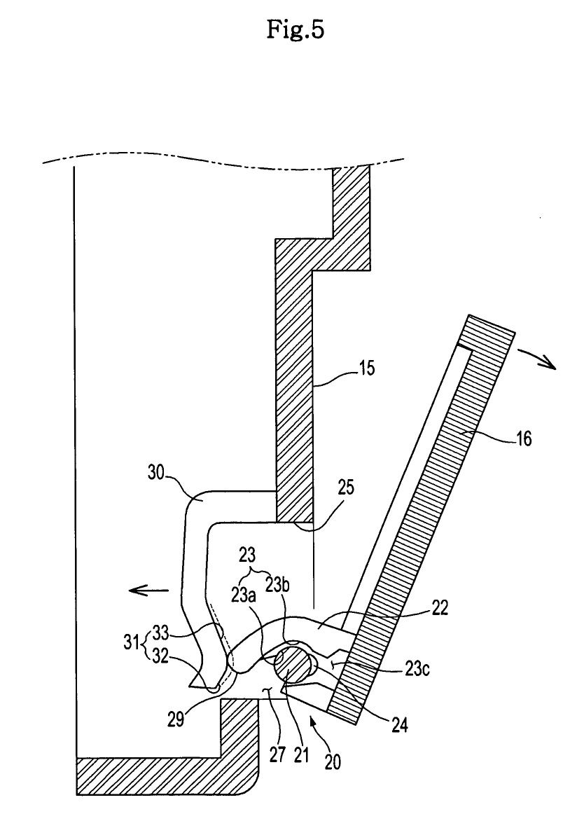

Operation of the door hinge device when the door is opened or closed will be described. As shown in FIG. 4, when the door 16 is closed, the damping protrusion 24 of the hinge shaft 21 is located in the separation groove 23c of the coupling member 22. Further, at this time, since the opening/closing protrusion 29 of the coupling member 22 contacts the closing guide surface 32 of the resilient member 30 and the door 16 tends to be hinged in the closing direction, the door 16 remains closed. In this state, as shown in FIG. 5, as the door 16 is opened, the opening/closing protrusion 29 of the coupling member 22 pushes the resilient member 30 in a rearward direction (indicated by an arrow) until the opening/closing protrusion 29 of the coupling member 22 reaches the uppermost point of the variably shaped flexible arm 31 of the resilient member 30. At this time, the damping protrusion 24 of the hinge shaft 21 is located in the separation groove 23c.

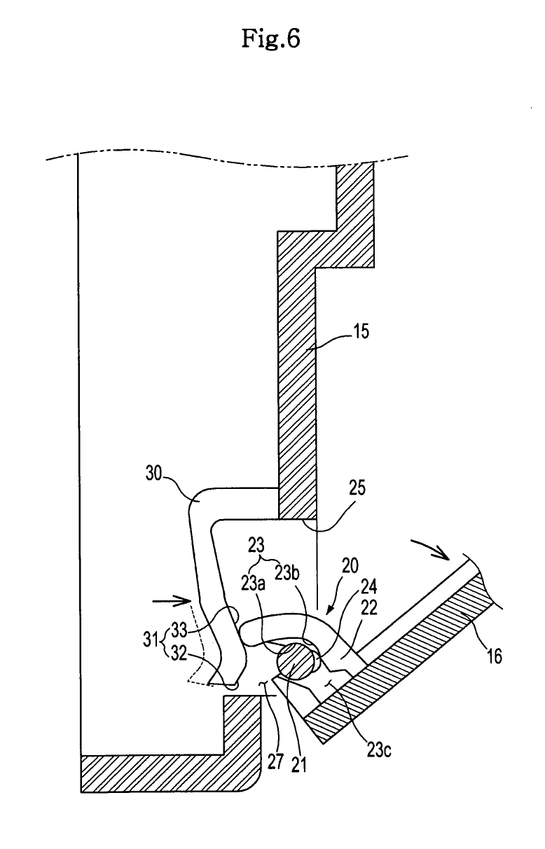

Additionally, as shown in FIG. 6, if the door 16 is further opened by a predetermined angle, restoring force of the resilient member 30 is applied to the opening/closing protrusion 29 of the coupling member 22 to allow the opening/closing protrusion 29 to be guided by the opening guide surface 33 from the moment that the opening/closing protrusion 29 of the coupling member 22 passes by the uppermost point of the variably-shaped flexible arm 31 and contacts the opening guide surface 33, so that the door 16 is hinged in the opening direction. Accordingly, from this moment, the door 16 can be easily opened.

Additionally, at a final stage of opening the door 16 from the position shown in FIG. 6 to the position shown in FIG. 7, since the damping protrusion 24 of the hinge shaft 21 remains in contact with the inner surface of the damping portion 23b of the coupling member 22, contact resistance occurs between the inner surface of the damping portion 23b and the damping protrusion 24. Accordingly, the door 16 can be slowly and smoothly opened, and even upon completion of opening the door 16, the door does not slam or tremble.

When a user rotates the door 16 in the closing direction from the position shown in FIG. 7 to the position shown in FIG. 5 in order to close the door 16, the opening/closing protrusion 29 of the coupling member 22 is brought into contact with the opening guide surface 33 of the resilient member 30, so that the resilient member 30 is slightly pushed in the rearward direction. Further, while the door 16 is closed from the position shown in FIG. 5 to the position shown in FIG. 4, the restoring force of the resilient member 30 is applied to the opening/closing protrusion 29 of the coupling member 22, and the closing guide surface 32 of the resilient member 30 compresses the opening/closing protrusion 29 in the closing direction of the door 16, so that the door 16 is automatically closed.

While shown with a shaft 21 on the body 10 and the coupling member 22 on the door 16, it is understood that other configurations are possible, such as the shaft 21 being on the door 16.

As apparent from the above description, the door hinge device according to an aspect of the invention can prevent the door from slamming or trembling by using the damping protrusion of the hinge shaft and the damping portion of the coupling member when opening the door. Additionally, since separate door dampers are not required, the electronic appliance can be simplified in structure, and thus reduced in manufacturing costs.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A door hinge device coupling a door to a body of an electronic appliance, comprising:
a hinge shaft fixed to the body of the appliance and having a damping protrusion on one side of an outer surface of the hinge shaft; and
a coupling member affixed to the door and having a shaft engaging hole engaging with the outer surface of the hinge shaft,
wherein the shaft engaging hole comprises a holding portion having an inner diameter corresponding to an outer diameter of the hinge shaft, and a damping portion having a larger inner diameter than the outer diameter of the hinge shaft and surrounding the damping protrusion, the damping portion comprising a separation section separated from the damping protrusion when the door is closed, and a contact section contacting the damping protrusion when the door is opened.

2. The door hinge device according to claim 1, wherein the coupling member comprises an opening/closing protrusion formed on the outer surface thereof, and a resilient member affixed to the body such that, when the door is opened or closed, the resilient member compresses the opening/closing protrusion to allow the door to be opened or closed.

3. The door hinge device according to claim 2, wherein the coupling member further comprises an open portion opened in a radial direction of the shaft engaging hole and having a narrower width than the outer diameter of the hinge shaft such that the hinge shaft enters the open portion, and engages with the coupling member.

4. The door hinge device according to claim 3, wherein the opening/closing protrusion extends from one end at the open portion of the coupling member to the resilient member.

5. The door hinge device according to claim 2, wherein the resilient member comprises a flexible arm provided to compress the opening/closing protrusion, the flexible arm comprising an opening guide surface slanted to compress the opening/closing protrusion in an opening direction of the door when the door is opened, and a closing guide surface slanted to compress the opening/closing protrusion in a closing direction of the door when the door is closed.

6. A door hinge device coupling a door to a body of an electronic appliance, comprising:
a hinge shaft fixed to the body of the appliance and having a damping protrusion on one side of an outer surface; and
a coupling member affixed to the door and having a shaft engaging hole engaging with the outer surface of the hinge shaft, the shaft engaging hole comprising a separation section separated from the damping protrusion when the door is closed, and a contact section contacting the damping protrusion when the door is opened.

7. An electronic appliance comprising a body, a door coupled to the body, and a door hinge device to rotateably couple the door to the body,
wherein the door hinge device comprises:
a hinge shaft fixed to the body of the appliance and having a damping protrusion on one side of an outer surface of the hinge shaft; and
a coupling member affixed to the door and having a shaft engaging hole engaging with the outer surface of the hinge shaft,
the shaft engaging hole comprising a holding portion having an inner diameter corresponding to an outer diameter of the hinge shaft, and a damping portion having a larger inner diameter than the outer diameter of the hinge shaft and surrounding the damping protrusion,
the damping portion comprising a separation section separated from the damping protrusion when the door is closed, and
a contact section contacting the damping protrusion when the door is opened.

8. The electronic appliance according to claim 7, wherein the coupling member further comprises an opening/closing protrusion formed on the outer surface thereof, and a resilient member affixed to the body such that, when the door is opened or closed, the resilient member compresses the opening/closing protrusion to allow the door to be opened or closed.

9. The electronic appliance according to claim 8, wherein the coupling member further comprises an open portion in a radial direction of the shaft engaging hole and having a narrower width than the outer diameter of the hinge shaft such that the hinge shaft enters the open portion, and engages with the coupling member.

10. The electronic appliance according to claim 9, wherein the opening/closing protrusion extends from one end at the open portion of the coupling member to the resilient member.

11. The electronic appliance according to claim 8, wherein the resilient member comprises a flexible arm provided to compress the opening/closing protrusion, the flexible arm comprising an opening guide surface slanted to compress the opening/closing protrusion in an opening direction of the door when the door is opened, and a closing guide surface slanted to compress the opening/closing protrusion in a closing direction of the door when the door is closed.

12. An electronic appliance having a body and a door connected by the door hinge device according to claim 1.

13. A door hinge coupling a door to a body of an apparatus, the door hinge comprising:
a hinge shaft fixed to one of the body or the door and having a damping protrusion on one side of an outer surface of the hinge shaft; and
a coupling member affixed to the other one of the body or door and having a shaft engaging hole engaging the outer surface of the hinge shaft,
wherein the shaft engaging hole comprises a holding portion and a damping portion, the damping portion being separated from the damping protrusion of the hinge shaft when the door is closed, and contacting the damping protrusion of the hinge shaft when the door is opened.

14. The door hinge according to claim 13, wherein the holding portion has an inner diameter corresponding to an outer diameter of the hinge shaft, and the damping portion has an inner diameter larger than the outer diameter of the hinge shaft and surrounding the damping protrusion.

15. The door hinge according to claim 13, further comprising a resilient member affixed to the body of the apparatus and compressing the coupling member when the door is opened or closed.

16. The door hinge according to claim 15, wherein the resilient member comprises a flexible arm having a variable shape and slanted to compress the coupling member in an opening direction of the door when the door is opened, and to compress the coupling member in a closing direction of the door when the door is closed.

17. A door hinge comprising:
a hinge shaft fixed to one of a body and a door of an apparatus, the hinge shaft having a damping protrusion on a side; and
a coupling member affixed to the other one of the body and the door of the apparatus to rotatably connect the body and the door, the coupling member having a damping portion,
wherein the damping protrusion of the hinge shaft is shaped to contact the damping portion of the coupling member when the door is moved backward and forward to prevent the door from slamming or trembling when substantially open and to not contact the damping portion when the door is substantially closed to allow the door to rotate relative to the body without interference from the damping protrusion.

18. The door hinge according to claim 17, wherein the coupling member further comprises a holding portion having an inner diameter corresponding to an outer diameter of the hinge shaft, and the damping portion has an inner diameter larger than the outer diameter of the hinge shaft and surrounding the damping protrusion.

19. The door hinge according to claim 17, further comprising a flexible member affixed to the body of the apparatus and compressing the coupling member when the door is opened or closed.

20. The door hinge according to claim 17, wherein the coupling member further comprises an open portion having a width smaller than an outer diameter of the hinge shaft.

21. An electronic appliance having a body and a door connected by the door hinge according to claim 13.

22. An electronic appliance having a body and a door connected by the door hinge according to claim 17.
